(19) United States
(12) Patent Application Publication
(10) Pub. No.: US 2002/0188673 A1
(43) Pub. Date: Dec. 12, 2002

(54) Data delivery

(76) Inventor: Roger Brian Gimson, Bristol (GB)

Correspondence Address: HEWLETT-PACKARD COMPANY, Intellectual Property Administration, P.O. Box 272400, Fort Collins, CO, 80527-2400, US

(21) Appl. No.: 10/106,466

(22) Filed: Mar. 26, 2002

(30) Foreign Application Priority Data
Mar. 28, 2001 (GB) 0107780.9

(51) Int. Cl. G06F 15/16

(52) U.S. Cl. 709/203

(57) ABSTRACT

A method of sending data held on a primary processing apparatus (2) to one or more data receiving devices is disclosed. On receiving a request for data, the method comprises arranging the data on a processing apparatus in two or more information levels such that a predetermined subset of the data comprising data at one of the information levels is sent to a particular device. Each level may compare data which is appropriate to the receiving device, for example, so that a shorter version of a text at one level is sent to a requesting mobile phone (26) while a full version of the text at another level is sent to a personal computer display (30).

This invention relates to an improved method and apparatus for providing data, especially, but not exclusively, to devices remote from a processing apparatus, such as a computer.

Many documents are now produced using computers. Such documents may be intended for printed publications, such as newspapers, magazines, books, etc. or for electronic publication, such as for e-mails, pages to be displayed on the World Wide Web, etc.

Page description languages are well known to achieve such computer-based preparation. These description languages provide instructions for a page renderer so that the final page can be produced from the given instructions. Therefore, the instructions provided to the renderer contain not only the content of the document, but also information about how the content should be arranged on the page (whether paper, or computer screen). Well known page description languages include LATEX, POSTSCRIPT, HTML.

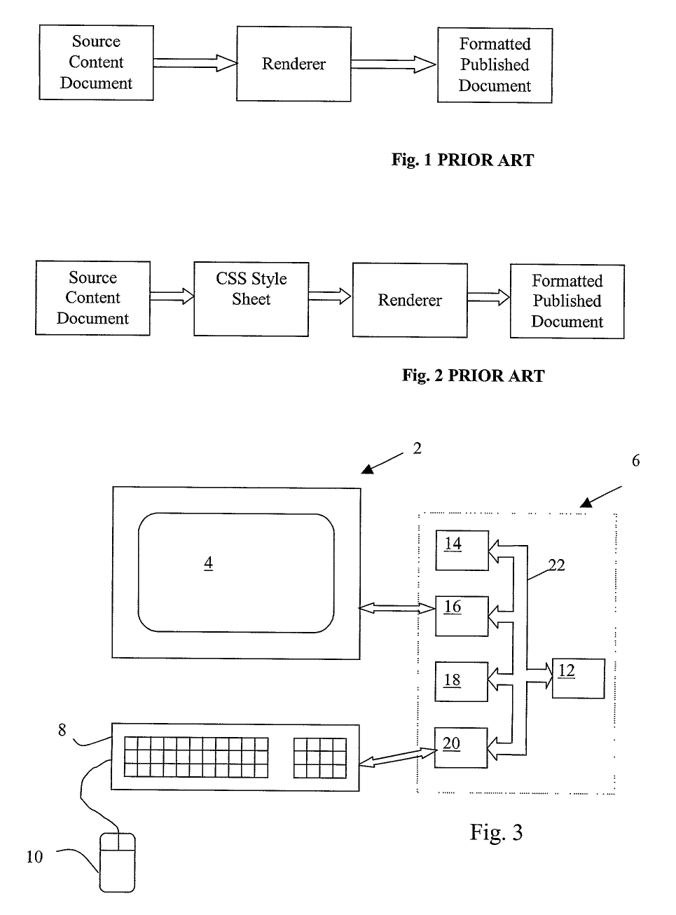

A problem with the use of such description languages is that a user cannot see what the finished document will look like until the instructions have been rendered, as shown in FIG. 1. Furthermore, the content document, containing the instructions, can look different on different display medium (for example HTML documents can look different when displayed on different browsers). This difference of display can result in a need to produce different documents arranged for each display medium, that on which it is intended to view the document.

The previously discussed problems can be increased when content description languages such as XML (extensible mark up language) are used to specify the content to be displayed. Unlike the traditional description languages described hereinbefore, XML does not necessarily contain information relating to the layout of the published document, but may simply define the information held within the content document. The person skilled in the art will readily understand this.

In certain situations an XML content document must be interpreted by an intermediate level before being passed to the renderer, as shown in FIG. 2. One such example of the intermediate level is a CSS style sheet language that converts, generally in conjunction with Document Type Definitions (DTD's), an XML content document into HTML for rendering. The use of such an intermediate level increases the complexity of creating a number of pages specifically designed for each display medium.

This problem is further increased by the current diversification of devices, and hence display mediums, upon which electronically published documents may be displayed. For example pages of the World Wide Web (or simply web) can now be accessed by devices such as WAP (Wireless Application Protocol) telephones, web enabled TV's, and Personal Digital Assistants (PDA's) (landscape, and portrait versions), printers, etc.

Such diversification can lead to an increased workload for publishers in ensuring that the content they are producing is suitable for display on a wide range of devices. Therefore, there is an ongoing need to try and simplify the process for publishing content on a number of different devices.

It is an object of this invention to try and contribute to ameliorating the problems discussed hereinbefore.

According to a first aspect of the invention there is provided a method of sending data held on a primary processing apparatus, to one or more data-receiving devices on receipt of a request for data, said method comprising arranging the data on the primary processing apparatus in two or more information levels such that a predetermined subset of the data comprising data at one of the information levels is sent to a particular data-receiving device when that device or another device requests data from the primary processing apparatus.

Such a method is advantageous because it allows data to be automatically sent to a data-receiving device upon a request from that device without user intervention, and helps to ensure that the data is correctly displayed on the data-receiving device.

Conveniently, the method comprises ensuring that the data sent from the primary processing apparatus to the data-receiving device is capable of being displayed by the data-receiving apparatus.

Preferably, the method comprises sending data between the primary processing apparatus and the data-receiving device via a network connection. An advantage of this is that it is possible for the two devices to be separated by great distances.

The method may use any one or more of the following network connections: a Local Area Network (LAN), a Wide Area Network, World Wide Web (including that used by WAP telephones), other internet connections (FTP, gopher, etc.), temporary connections (such as Bluetooth, IRDA, etc.), Ethernet connections, etc.

The method may comprise writing the data held on the server in a mark-up language, which may be XML, or may be any other suitable language. XML is advantageous due to its emerging importance as the language that makes data easy to search, and its replacement of HTML as the language of the Web. SGML is another suitable mark up language.

In an alternative, the data may be stored as a database including a number of well defined and related records and fields instead of as a mark-up document.

The method may comprise transforming the data held on the primary processing apparatus before it is sent to a data-receiving device. The transformation may be performed using a language such as XSL (eXtensible Stylesheet Language), or any other suitable sequence of instructions, for example provided by a programming language. An advantage of such a transformation is that allows appropriate sub-items of the data, suitable for the requesting data-receiving device, to be selected for transmission, and also allows the presentation for each of the sub-items to be specified. (XML may not contain any formatting information, and it is therefore desirable to specify the format of the data in some manner).

Conveniently the method comprises associating data-receiving devices capable of communicating with the primary processing apparatus with a predetermined information level. Such a method is advantageous because when a data-receiving devices requests data from the server it is simply a matter of sending the desired data at the appropriate information level.

An information level may be thought of as a subset of the data. Typically, selecting the data at some information level results in a different quality or quantity of data than selecting it at some other information level. Exactly what subset of the data will be selected at any one level is the choice of the creator or other processor of the data.

Each information level may provide an alternative edition of the data held on the primary processing apparatus. An advantage of such an arrangement is that each information level provides an edition that provides substantially similar content as the others but at varying degrees of conciseness. A user can obtain the essence of the content by viewing any of the editions.

This differs from the prior art, as provided for example by EP 0 766 183. The system described in EP 0 766 183 assigns graphical priorities to the elements of documents and ensures that visually significant features appear early during presentation. This graphical sequencing only affects the order of presentation of a single edition and does not provide an alternative edition of the data, unlike the present system.

The data sub-items may comprise individual pictures, packets of sound, etc. However, in the preferred embodiment the data sub-items comprise words. Such a method is advantageous since it allows the overall data to be more compact.

The invention is particularly applicable to words since it is possible to reduce the length of the data contained in an information level, and still keep the essence of the data. As discussed hereinbelow, it is possible to arrange data in the information levels in a variety of different manners, such that the data can be efficiently stored therein.

In one embodiment data sub-items are individually marked to indicate to just which information level they belong. In alternative embodiments a data sub-item may be grouped and said groups may be marked as belonging to an information level. A data sub-item group may comprise a group of words, such as a sentence, paragraph, etc., a group of pictures, a group of sound packets, etc. An advantage of such an embodiment is that the order of the data sub-items can be re-ordered in different sub-item groups. This is particularly advantageous when the data sub-items are words; when shortening a piece of text it is sometimes appropriate to re-order the words.

The method may comprise providing the primary processing apparatus with data, and having the primary processing apparatus generate the information levels. This is advantageous because it simplifies the process for a creator, however, it removes any control of the content from the creator.

Such information level generation may require no input from the creator or may require a creator to specify parameters, etc. The primary processing apparatus may provide that creator with a set of tools to aid generation of the information levels. Some form of creator input may be desirable to ensure that they are happy with the information content. For example, a data creation tool, such as a word processor, or a web page editor, may be enhanced to allow the creator to enter and view multiple versions of a piece or content, suitable for different information levels.

Alternatively, a creator may generate the information levels manually. Such manual generation may be by way of writing a suitable XML document, or a document in any other suitable page description language.

The method may comprise determining the identity of the data-receiving device that has requested data, (or had data requested for it) before data is sent from the primary processing apparatus. The primary processing apparatus may then only send the information level that the data-receiving device is capable of displaying. An advantage of such a method is that the correct information level can be sent to the data-receiving device, for correct display.

It may be possible to determine the capabilities of the data receiving device from the request for example from information included as part of the request header when using Hypertext Transfer Protocol (HTTP). One way for representing such information is using the proposed Composite Capabilities Preferences Profile (CC/PP) currently being defined by the World Wide Web Consortium (W3C). In another embodiment it may be possible to rely on an interaction protocol, such as on the HP JETSEND INTERACTION PROTOCOL (JIP) as described in EP 0 872 991 to negotiate an appropriate form of content. This too, allows devices of a different nature to communicate.

Alternatively, or additionally, the primary processing apparatus may initially send the highest information level of data (i.e. the most detailed) to a data-receiving device requesting data, and on receipt of an error message from the data-receiving device send the next information level until the data is correctly transmitted. An advantage of such a method is that the primary processing apparatus does not need to know the nature of the device to which it is sending data, which can sometimes be problematic to determine.

In yet another embodiment, the primary processing apparatus may initially send the lowest level of data (i.e. the least detailed) to a data-receiving device requesting data, on complete transmission of the data send the next information level of data, and repeat this method until an error message is returned. An advantage of such a method is that the least detailed level of data will transmit quickly and therefore allow information to display on the data-receiving device quickly. The data-receiving device may be arranged to immediately display the least detailed level of data and leave this on display until the highest data level it can handle has been received, caching any levels in-between.

The skilled person will appreciate the FLASHPIX™ algorithm for images, wherein a single image is coded at a number of different information levels. The lowest information level is transmitted first and allows the receiving device to display a low resolution of the image. Then, as further information levels are received, the resolution of the image can be increased, until all of the data has been received, and the completed image can be displayed. Of course, the FLASHPIX™ algorithm does not tailor the data delivery to a variety of different devices, but is aimed at speeding the display of an image on any data-receiving device that is receiving the data.

The method may provide 2, 3, 4, 5, 6, 7, 8, 9, 10, 15, 20, 40, 50 or more information levels, or any number in between those shown.

Alternatively, or additionally, the method may comprise creating a new information level by processing the data held on the primary processing apparatus as data is requested according to the data display characteristics of the data-receiving device requesting the data i.e. request the data held on the primary processing apparatus on demand. Such a method may therefore provide an infinite amount of information levels, and provide data that is tailored to the requesting data-receiving device. The information in the new level may be an intelligible summary of the data tailored to a particular display.

Preferably the information levels are arranged in a hierarchical structure, with the highest data levels containing the most information. In some embodiments the data in the information levels is arranged such that to send data at one particular level requires data in the levels below that particular level to be sent. Such an arrangement is advantageous because it provides for efficient storage of the data and helps to prevent duplication of the data.

The term “information level” may be replaced with terms such as “alternative edition” or similar phrases.

According to a second aspect of the invention there is provided a primary processing apparatus arranged to hold data arranged in two or more information levels, and comprising processing circuitry including a transmitter and receiver, the receiver arranged to receive a data request and pass said request to the processing circuitry, on receipt of such a data request said processing circuitry being arranged to select a subset of the data held thereon comprising data at an information level, and cause said transmitter to transmit said subset of data.

The primary processing apparatus may comprise a phone, television, or perhaps (most typically) a personal computer or a server.

According to a third aspect of the invention there is provided a computer readable medium holding a program arranged to run the method of the first aspect of the invention.

A computer readable medium may comprise any one of the following: a floppy disk, a CDROM, a DVD ROM/RAM, a ZIP disk, LS120 disk, any other suitable physical format, a transmitted signal, an internet download, etc.

According to a fourth aspect of the invention comprising a method of organising data on a primary processing apparatus, the data being capable of being sent to one or more data-receiving devices on receipt of a request for data, said method comprising arranging the data on the primary processing apparatus in two or more information levels such that a predetermined subset of the data comprising data at one of the information levels is sent to a particular data-receiving device when that device requests data from the primary processing apparatus.

According to a fifth aspect of the invention there is provided a data-receiving device that is controlled by a program, wherein the program is tailored to facilitate communication with the apparatus of the second aspect of the invention.

The data-receiving apparatus may be any one or more of the following: a WAP telephone, a web enabled tv, a PC, a PDA, an ebook, any other suitable access device. It may alternatively be a printer.

The data-receiving device (or data requesting device) may be arranged to communicate the capabilities of the data receiving device to the primary processing apparatus. The device may send its identity and the processing apparatus may determine the capabilities from the identity, e.g. using a suitable database of device identities. An advantage of this feature is that it simplifies sending the appropriate information level to the data-receiving device.

Alternatively, or additionally, the data-receiving device (or data requesting device) may be arranged to communicate to the primary processing device the information level that it is appropriate to send. This is an alternative, but also advantageous, way to simplify the selection of an appropriate information level.

The data-receiving device or data requesting device may be arranged to send the capabilities of the data receiving device and/or the appropriate information level when a request for data is made. Alternatively, or additionally it may be arranged to send its identity and/or appropriate information level when requested to do so by the primary processing apparatus.

Preferably the data-receiving device is arranged to return an error code if the data that it is sent cannot be correctly displayed. An advantage of this is that a more appropriate information level can then be resent.

There now follows by way of example a detailed description of the present invention with reference to the accompanying drawings of which:

FIGS. 1 and 2 show prior art solutions for sending data to a data-receiving device;

FIG. 3 schematically shows the architecture of a computer capable of acting as a server for this invention;

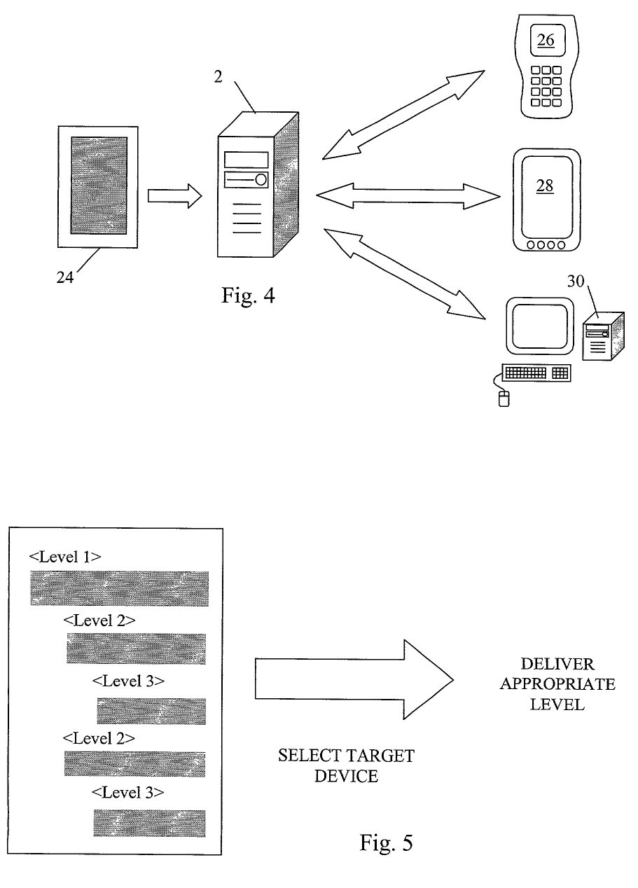

FIG. 4 schematically shows how a single page can be published on to a number of different devices; and

FIG. 5 schematically shows the sending of target data to a data- receiving device.

This particular invention is applicable to distribute data electronically, and in particular via the World Wide Web, or in short the web. Such technology is well known. Generally the data to be distributed is held on a primary processing apparatus, or server 2, as shown in FIG. 3, and can be requested by any number of devices that are capable of communicating with the server 2. Indeed, a first device can make a request for data to be sent to a second device.

In this embodiment the server 2 comprises a display 4, processing circuitry 6, a keyboard 8, and mouse 10. The processing circuitry 6 further comprises a processing unit 12, a hard drive 14, a video driver 16, memory 18 (RAM and ROM) and an I/O subsystem 20 which all communicate with one another, as is known in the art, via a system bus 22. The processing unit 12 comprises an INTEL PENTIUM series processor, running at typically between 700 MHz and 1.2 GHz.

As is known in the art the ROM portion of the memory 18 contains the Basic Input Output System (BIOS) that controls basic hardware functionality. The RAM portion of memory 18 is a volatile memory used to hold instructions that are being executed, such as program code, etc. The hard drive 14 is used as mass storage for programs and other data.

Other devices such as CDROMS, DVD ROMS, network cards, etc. could be coupled to the system bus 22 and allow for storage of data, communication with other computers over a network, etc.

The server 2 could have the architecture known as a PC, originally based on the IBM specification, but could equally have other architectures. The server could may be an APPLE, or may be a RISC system, and may run a variety of operating systems (perhaps HP-UX, LINUX, UNIX, MICROSOFT NT, AIX™, or the like).

In this embodiment data, in this case a document 24 is input to the server 2, which stores the data and distributes it on request to a requesting data-receiving device. The requesting data-receiving device can be any device that is capable of communicating with the server 2. When the server 2 receives a request from a data-receiving device or another device it will forward the requested data onto the data-receiving device.

Under web protocols the server 2 is given a unique address, which is commonly referred to as a URL, or “Uniform Resource Locator”. The URL generally takes the format http://hostname/ . . . where “hostname” is the address of the server. According to known protocols this URL is mapped into an address, generally through use of a nameserver.

A common Internet protocol that governs the transmission of data across the web is HTTP (Hypertext Transfer Protocol). This ensures that a URL entered is correctly translated in to a server address and subsequently governs how, and what data is sent across the web. As long as a device can communicate using HTTP it can communicate with the web, and consequently the server 2.

Indeed, FIG. 4 shows a variety of devices that can communicate with the server 2; including a WAP (Wireless Application Protocol) telephone 26, a PDA 28 (Personal Digital Assistant), and a PC 30. This list of devices that can request data from the server is not exhaustive. It will be appreciated that the display characteristic of each of the devices mentioned varies substantially.

An example of a WAP enabled telephone is the NOKIA 7110 that has a black and white display of 96×65 pixels, but only 96×44 pixels are available for body data providing 4 lines of text at roughly 15 characters per line.

In this example the PDA 28 is an HP Jornada 690 that operates using the Microsoft Windows CE operating system, and runs Microsoft Pocket Explorer as it means of communicating with the server 2. The Jornada 690 has a keyboard, as well as a touch screen input, and can access the web, etc. using modem, or network cards connected through its PC card slot. The screen of the Jornada 690 can display colour and has a resolution of 640×240 pixels(i.e. landscape). (It is also possible for the PDA to have a portrait perspective screen).

The PC 30 can have an architecture similar to that shown in FIG. 3. Its display is likely to be able to display 24-bit true colour (in excess of 16 million colours) at a resolution of 1024×768.

From the preceding paragraphs it will be appreciated that each of the devices shown in FIG. 4 (the WAP telephone 26, the PDA 28, and the PC 30) each have different display properties. Therefore, a document tailored for one of the devices will not necessarily be displayed correctly on the other devices.

Therefore, the data that is stored on the server 2 is structured in such a way that the requesting device can be sent the data in an appropriate format for display. The data is stored using XML (eXtensible Mark-up Language), but could be equally stored using other mark-up languages or as a database. XML requires pairs of tags to be placed within a document. Theses tags do not specify how the information should be presented, but specify the content of the information between the pairs of tags. The skilled person will fully understand XML, but a full description can be found at http://www.w3.org, and the brief description below will aid his/her understanding.

Example data written in XML, is shown in the Appendix. The skilled person will appreciate how an XML document is structured: written in words, or data sub-items, which are collected into data sub-item groups. The data sub-item groups can comprise sentences, paragraphs, or simply collections of words. The data sub-item groups, or even just data sub-items, are placed between pairs of tags.

The tags appear as follows: <variable>, and </variable>, with variable being any word, or character string acceptable according to the XML recommendation. Further, each data sub item group can be itself broken down into a number of sub-items. This structure is convenient and allows for easy manipulation and searching of the complete data item.

In Example 1 of the Appendix, the name of a person is represented using the opening XML tag <name> and the closing XML tag </name>. Within these tags are three separate sub-items that specify the title, first name and last name of the person. Each sub-item has its own corresponding tags. Using these tags, it is easy to extract one or more selected parts of the data.

The examples in the Appendix also show alternative embodiments for performing the present invention. They are structured in such a manner that a server 2 can readily extract suitable data, or a suitable information level, for sending to each of the data-receiving devices 26, 28, 30.

For example, in Example 2, some text to be used as a title, which appears between the tags <title> </title>, is given in short, medium and long versions, each with suitable tags. As the tags would suggest, the content of the <long> tags is more verbose and the content of the <short> tags is less verbose than that contained by the other tags. Therefore the server 2 can select which level of verbosity is appropriate to send to the requesting data-receiving device.

Example 3 shows a similar distinction, between short, medium and long versions, applied to a longer description. In this case, the long version is itself broken down into a number of separate paragraphs.

In Example 4, the description text is marked as belonging to three different nested levels. Here, rather than these levels being alternates, it is expected that text tagged as being at a specific level includes any nested text marked at a higher numeric level.

As the skilled person will appreciate, unlike an HTML document, the XML data item contains no information about how the document should be presented on the display of a device. Therefore, an XSL stylesheet may be used to select and specify how the appropriate XML elements will be presented on the display.

For example a stylesheet is provided for each of the data-receiving devices that can access the server 2 that it is desired to support. That is in the example given a separate stylesheet would be written for the WAP telephone 26, the PDA 28 and the PC 30. Once written this stylesheet would be capable of selecting appropriate data sub-items by selecting the correct information level, and so avoids the need to write separate data items for each of the data-receiving devices 26, 28, 30.

Clearly, in the example given, the WAP telephone 26 has the most limited data display capabilities. Therefore, the XML data item may be structured such that only the last name element <last_name> of a name, and only the shortest <short> or <level_{—}3> part of a title or description are sent when a WAP telephone requests data. The XSL stylesheet would ensure that this happens.

Conversely, in the example given, the PC 30 has the most capable display capabilities, and therefore, it is appropriate to send all of the available data to the PC 30 requesting data. The whole of a name would be sent, including <title>, <first_name> and <last_name>. The <long> part of a title or description would be sent. The <level_{—}1> version of a description, which includes the nested <level_{—}2> and <level_{—}3> components, would be sent.

The methodology described in relation to the Appendix is schematically shown in FIG. 5.

As will be appreciated, the data held on the server 2 could be organised in any number of different manners. One such alternative is shown in Examples 3 and 4. In Example 3, three alternative forms of the text are provided, short medium and long. In Example 4, the text is marked as belonging to three different nested levels, <level_{—}1>, <level_{—}2> and <level_{—}3>. The <level_{—}3> text in Example 4 corresponds to the <short> text of Example 3. The <level_{—}2> text, which includes the <level_{—}3> text, corresponds to the <medium> text, and the <level_{—}1> text of Example 4, which includes both <level_{—}2> and <level_{—}3>, corresponds to the <long_text> in Example 3.

Varying forms of shortening may be used to arrive at the short version from the long version. For example, shorter synonyms may replace words from the long version, adjectives may be dropped, the word order may be changed, abbreviations may be used, etc. and such techniques will be readily apparent to the skilled person. A variety of these techniques have been used in the XML code in the Appendix.

The data, in this case the document 24, can be created in a number of different manners. It is of course possible for an author to hand draft the document 24, but it may also be possible for the server 2 (or other processing apparatus) to generate the different information levels.

An example of a situation in which this invention could be applied is as follows. A restaurant review may consist of over 1000 words in the full version. This full version may be suitable for delivery to a web browser on a PC, but not for a device with a small screen such as a WAP telephone. Here the most abbreviated version of the review may be delivered initially, with more detail supplied on request.

Another possible way of efficiently providing the most appropriate form of content to a receiving device is by using a negotiation protocol such as JetSend (as described in EP 0872991): the providing device can offer a hierarchy of content types, and the receiving device can offer its preferences, generally leading to provision to the receiving device of the richest content that it can use effectively.

APPENDIX
Example 1
<name>

<title>Dr</title>
<first_name>Roger</first_name>
<last_name>Gimson</last_name>
</name>

Example 2
<title>

<short>Custom Pub</short>
<medium>Custom Publishing</medium>
<long>Device Independent Custom Publishing</long>

</title>
Example 3
<description>

<short>
The adaptation of content for delivery across many kinds of web

device.

</short>
<medium>

Our work is exploring ways of making it easier to adapt content for
delivery across many kinds of web device. Information can be held in a
single representation and adapted for presentation in a range of formats.

</medium>
<long>
<paragraph>

Web content is becoming available through many devices
besides the personal computer. Phones, TVs, personal organisers and
dedicated web appliances will all be able to access web information.
This is a problem for web publishers who have the additional cost
of re-authoring their content to make it suitable for each device.

</paragraph>
<paragraph>

Our work is exploring ways of making it easier to adapt
content for delivery across many kinds of web device. Our demonstration
shows how information can be held in a single representation and adapted
for presentation in a range of formats.

</paragraph>
<paragraph>

For example, it is possible to show detailed information on a
PC screen and on a printer. However, on a low-resolution screen such as a
TV set, or on a small device such as a palmtop organiser, only selected
parts of the information are shown. On each device the layout of the infor-
mation is customised to suit the presentation capabilities of the device.

</paragraph>

</long>

</description>
Example 4
<description>

<level_1>

Web content is becoming available through many devices besides
the personal computer. Phones, TVs, personal organisers and dedicated
web appliances will all be able to access web information. This is a
problem for web publishers who have the additional cost of re-authoring
their content to make it suitable for each device.

<level_2>

<level_3>

Our work is exploring ways of making it easier to
adapt content for delivery across many kinds of web device.

</level_3>

Our demonstration shows how information can be held in a
single representation and adapted for presentation in a range of formats.

</level_2>

For example, it is possible to show detailed information on a PC screen
and on a printer. However, on a low-resolution screen such as a TV set,
or on a small device such as a palmtop organiser, only selected parts of
the information are shown. On each device the layout of the information is
customised to suit the presentation capabilities of the device.

</level_1>

</description>

1. A method of sending data, said data being heldon a primary processing apparatus capable of receiving a request for data, to at least one data-receiving device, said method comprising arranging said data on said primary processing apparatus in at least two information levels, said information levels being arranged such that said information levels comprise a predetermined subset of said data held on said primary processing apparatus and the method further comprising sending at least one of said information levels to a particular data-receiving device on receipt by said primary processing apparatus of a said request for data.

2. A method according to claim 1 comprising arranging said information levels such that each of said information levels provides an alternative edition of said data such that each of said alternative editions contains substantially the same information as any other of said editions.

3. A method according to claim 1 wherein said data-receiving device is capable of displaying data and said method comprises ensuring that said data sent from said primary processing apparatus to said data-receiving device is capable of being displayed by said data-receiving device.

4. A method according to claim 1 wherein a network connection capable of transmitting data is provided and said method comprises sending said data from said primary processing apparatus to said data-receiving via said network connection.

5. A method according to claim 1 comprising writing said data held on the primary processing apparatus in a mark-up language.

6. A method according to claim 5 wherein said mark-up language is XML.

7. A method according to claim 1 wherein said primary processing apparatus is capable of transforming said data, and said method comprises transforming said data held on said primary processing apparatus before said data is sent to said at least one data-receiving device.

8. A method according to claim 7 wherein a defining document using a mark-up language is provided for use in transforming said data held on said primary processing apparatus.

9. A method according to claim 8 wherein said defining document is written in XSL.

10. A method according to claim 7 wherein a specific sequence of instructions in a programming language are provided for use in transforming said data held on said primary processing apparatus.

11. A method according to claim 7 wherein transforming said data held on said primary processing apparatus allows said predetermined subset of said data held on said primary processing apparatus to be selected to be sent to said particular data-receiving device.

12. A method according to claim 7 wherein transforming said data held on said primary processing apparatus allows the presentation to be specified for each subset of said data held on said primary processing apparatus.

13. A method according to claim 1 which comprises associating said data-receiving devices capable of communicating with said primary processing device with a predetermined one of said information levels.

14. A method according to claim 1 wherein said data comprises at least one data sub-item and said method comprises marking each of said data sub items to indicate the information level to which said data sub item belongs.

15. A method according to claim 1 wherein said data comprises at least one data sub-item and said method comprises grouping said data sub-items and further marking each group as belonging to an information level.

16. A method according to claim 1 wherein said primary processing apparatus is provided with data and generates said information levels from the data with which it is provided.

17. A method according to claim 1 wherein said primary processing apparatus is provided with a set of tools to enable a user to generate said information levels and said method comprises said user generating said information levels using said set of tools.

18. A method according to claim 1 comprising determining the capability of said data receiving device to receive data before said data held on said primary processing apparatus is sent.

19. A method according to claim 18 comprising only sending information levels that said data receiving device that is to be sent data is capable of receiving once the said capability has been determined.20.

20. A method according to claim 1 comprising arranging said information levels in a hierarchical structure according to the level of detail of their content wherein the highest information level contains the most detail and the lowest information level contains the least detail.

21. A method according to claim 20 wherein said primary processing apparatus is capable of receiving an error message, said data-receiving device is capable of sending an error message and said method comprises the following steps; i) causing said primary processing apparatus to send said data at a first information level; ii) on receipt of a said error message from said data-receiving device to send said data at a further, lower, information level iii) repeating steps i and ii until said information has been correctly sent to said data receiving device.

22. A method according to claim 20 wherein said primary processing apparatus is capable of receiving an error message, said data-receiving device is capable of sending an error message and said method comprises the following steps: i) causing said primary processing apparatus to send said data at a first information level; ii) then to send said data at a second information level higher than the first; iii) to repeat steps i and ii until an error message is returned to said primary processing apparatus from said data receiving device.

23. A method according to claim 19 comprising arranging said data held on said primary processing apparatus such that to send data at a particular one of said information levels requires data in the information levels below said particular information level to be sent.

24. A primary processing apparatus capable of holding data, said data being arranged in at least two information levels, said primary processing apparatus comprising processing circuitry, a transmitter arranged to transmit data and a receiver arranged to receive a data request, and on receiving a said data request to pass said request to said processing circuitry, said processing circuitry being capable of selecting a subset of data from said data held on the primary processing circuitry on receipt of said request, said subset of data comprising data at at least one of said information levels, and of causing said transmitter to transmit said subset of data.

25. A computer readable medium holding instructions capable of causing a computer to perform the method of claim 1 where loaded thereonto.

26. A method of organising data on a primary processing apparatus, capable of holding data, of receiving a request for data, and of sending said data to at least one data-receiving device on receipt of a request for data, said data-receiving device being capable of sending a request for data, said method comprising arranging said data held on said primary processing apparatus in at least two information levels, each of said information levels comprising a predetermined subset of said data, said method comprising sending data at one of said information levels to a particular data-receiving device on receipt by said primary processing apparatus of a request for data sent from said particular data-receiving device.

27. A data-receiving device arranged to be controlled by a program, said program being tailored to facilitate communication with said primary processing apparatus of claim 24.

28. A device according to claim 27 wherein said device is capable of communicating its capability to handle said data to said primary processing apparatus.

29. A device according to claim 27 wherein said device is capable of communicating to said primary processing apparatus which of said information levels it is appropriate to send.

30. A device according to claim 28 wherein said device communicates its capability to said primary processing apparatus when said device makes said request for data.

31. A device according to claim 28 wherein said primary processing apparatus is capable of sending a request for the capability of said device, and said device communicates its capability to said primary processing on receipt of said request.

32. A device according to claim 29 wherein said device is arranged to communicate to said primary processing apparatus which of said information levels it is appropriate to send when said device makes said request for data.

33. A device according to claim 29 wherein said primary processing apparatus is capable of sending a request for the said information levels it is appropriate to send, and said device is arranged to communicate the said information level it is appropriate to send on receipt of said request.

34. A device according to claim 27 wherein said device is capable of displaying data, of generating an error code and of transmitting said error code to said primary processing apparatus if the data that is sent cannot be correctly displayed.

35. A method of sending data, said data being held on a primary processing apparatus capable of receiving a request for data, to at least one data-receiving device, said method comprising arranging said data on said primary processing apparatus in at least two information levels, said information levels being arranged such that said information levels comprise a predetermined subset of said data held on said primary processing apparatus and the method further comprising sending at least one of said information levels to a particular data-receiving device on receipt by said primary processing apparatus of a said request for data and further comprising arranging said information levels such that each of said information levels provides an alternative edition of said data such that each of said alternative editions contains substantially the same information as any other of said editions.

36. A method of sending data, said data being held on a primary processing apparatus capable of receiving a request for data, to at least one data-receiving device, said method comprising arranging said data on said primary processing apparatus in at least two information levels, said information levels being arranged such that said information levels comprise a predetermined subset of said data held on said primary processing apparatus and the method further comprising sending at least one of said information levels to a particular data-receiving device on receipt by said primary processing apparatus of a said request for data and further comprising determining the capability of the data receiving device to receive data before said data held on said primary processing apparatus is sent.

37. A method of sending data, said data being held on a primary processing means capable of receiving a request for data, to at least one data-receiving means, said method comprising arranging said data on said primary processing means in at least two information levels, said information levels being arranged such that said information levels comprise a predetermined subset of said data held on said primary processing means and the method further comprising sending at least one of said information levels to a particular data receiving means on receipt by said primary processing means of a request for data.
